(19) United States
(12) Patent Application Publication
(10) Pub. No.: US 2025/0362141 A1
(43) Pub. Date: Nov. 27, 2025

(54) METHOD AND APPARATUS FOR ESTIMATING BRAKE WEAR EMISSIONS OF VEHICLE

(71) Applicants: Hyundai Motor Company, Seoul (KR); Kia Corporation, Seoul (KR)

(72) Inventors: Vladimir Supik, Russelsheim (DE); Jan Bender, Russelsheim (DE); Eckhard Linke, Russelsheim (DE); Kristof Gertner, Russelsheim (DE)

(21) Appl. No.: 19/215,641

(22) Filed: May 22, 2025

(30) Foreign Application Priority Data
May 22, 2024 (DE) 102024114265.0

(51) Int. Cl. G01C 21/34

(52) U.S. Cl. CPC G01C 21/3469; G01C 21/3492

(57) ABSTRACT

A computer-implemented method and apparatus for estimating brake wear emissions of a vehicle include: obtaining a departure location and a destination location, accessing a navigational system for selecting a candidate route between the departure location and the destination location, accessing a database for obtaining vehicle parameters and a pre-defined data set of brake wear parameters, determining brake actions of the vehicle based on the selected candidate route and the vehicle parameters, and determining brake wear emissions based on the estimated brake actions and the pre-defined data set of brake wear parameters.

### CROSS-REFERENCE TO RELATED APPLICATION

This application claims under 35 U.S.C. § 119(a) the benefit of German Patent Application No. 102024114265.0 filed on May 22, 2024, the entire contents of which are incorporated herein by reference.

### BACKGROUND

### (a) Technical Field

The present disclosure pertains to a computer-implemented method and apparatus for estimating brake wear emissions of a vehicle and a corresponding computer program and vehicle.

### (b) Description of the Related Art

In a current driving situation, the friction brake is mainly used to cause brake emissions in the form of airborne particles. Brake emissions are part of non-exhaust emissions and are thus considered dangerous and carcinogenic. For reducing emissions, the brake wear emissions should also be limited. Further development of hardware solutions, such as hard-material coated brake discs and special pads for reducing brake emissions, is still ongoing. However, it is expected that these developments add further costs to vehicle hardware.

U.S. Pat. No. 8,255,152 B1 describes a navigation system that utilizes fuel use and emission criteria as a parameter to determine directions between two locations.

### SUMMARY

There is a need to find a more cost-effective solution to reduce brake wear emissions.

The present disclosure provides a computer-implemented method for estimating brake wear emissions, a computer program, and a vehicle.

According to the present disclosure, a computer-implemented method for estimating brake wear emissions of a vehicle includes: obtaining, by a controller, a departure location and a destination location of the vehicle; accessing, by the controller, a navigational system for selecting a candidate route between the departure location and the destination location; accessing, by the controller, a database for obtaining vehicle parameters and a pre-defined data set of brake wear parameters; determining, by the controller, brake actions of the vehicle based on the selected candidate route and the vehicle parameters; and determining, by the controller, brake wear emissions based on the estimated brake actions and the pre-defined data set of brake wear parameters.

According to one aspect of the disclosure, a computer-implemented method for estimating brake wear emissions of a vehicle is provided. The method comprises obtaining a departure location and a destination location; accessing a navigational system for selecting a candidate route between the departure location and the destination location; accessing a database for obtaining vehicle parameters and a pre-defined data set of brake wear parameters; determining brake actions of the vehicle based on the selected candidate route and the vehicle parameter; and determining brake wear emissions based on the estimated brake actions and the pre-defined data set of brake wear parameters.

According to a second aspect of the disclosure, a computer program comprising computer-readable instructions causing a computer to execute the inventive computer-implemented method is provided.

According to a third aspect of the disclosure, vehicle comprising a computer-readable storage medium comprising the computer program is provided.

One idea of the present disclosure is to use a software-based solution to predict the brake wear emissions precisely in advance and optimize the brake wear emissions by selecting a proper route.

The disclosure thus provides a method to predict and optimize brake wear emissions to measure and lower the vehicle's environmental impact. A key element is a forecast model, which consists of a pre-defined data set for the vehicle type and brake design. The forecast model also includes a prediction of brake actions on a candidate route. The combination of the pre-defined data set comprising brake wear parameters and the predicted brake actions based on vehicle parameters delivers the expected brake wear emissions on the planned candidate route. By suggesting an optimized route, the brake wear emissions can be lowered.

The present disclosure thus provides the advantage of a precise prediction of brake wear emissions, which depends on a vehicle type and estimated braking actions. The present disclosure further provides the possibility of an optimization of brake wear emissions by proposing an alternative route, as will be described further below. Thus, the amount and intensity of the real braking actions can be reduced, thereby reducing the emission of the vehicle.

A brake action can be understood as taking place when hydraulic pressure is applied to the mechanical wheel brakes of a vehicle. During such a brake action, the brake pads come in contact with the friction surface of the brake discs. The brake actions include the amount and intensity of braking. The amount and intensity of brake actions are influenced by various factors including the vehicle parameters. The selected route provides default vehicle parameters such as a speed profile and map data including traffic signs.

The pre-defined dataset is created for each vehicle and possible brake design individually during the research and development phase of the brake to provide the brake wear parameters. It also defines the impact of the brake actions on the environment in the form of brake wear emissions. The prediction of the brake wear emissions is done by combining the predicted brake actions with the pre-defined dataset in the form of a database, which may be a look-up table. This process is done for all predicted brake actions on the route

Advantageous embodiments and improvements of the present disclosure are found in the subordinate claims.

According to an embodiment of the disclosure, the pre-defined data set of brake wear parameters include basic brake wear emission parameters including characteristic particle emissions. The particle emissions were simulated for a certain brake action based on e.g. the vehicle speed, the braking pressure and the duration of brake for creating the brake wear parameters of the pre-defined data set.

According to an embodiment of the disclosure, the basic brake wear emission parameters include at least one of a particle size, a distribution of the particle size, and a flow direction of the particles. This enables to simulate a flow of the brake emissions flow by computational fluid dynamics. Via mathematical integrations and particle image velocimetry (PIV), the brake wear emissions may be calculated between a speed of 10 km/h up to maximum vehicle speed. By this, the pre-defined dataset is created as a database. These provide the brake wear emissions for a certain brake action that is described by the vehicle speed, the braking pressure and the duration.

According to an embodiment of the disclosure, the pre-defined data set of brake wear parameters include at least one of a brake type and a brake design. This improves the accuracy of the determination or estimation of the brake wear emissions

According to an embodiment of the disclosure, the vehicle parameters include a weight of the vehicle. The weight of the vehicle influences the amount and intensity of the brake actions. In this way, the accuracy of the determination of the brake wear emissions is improved.

According to an embodiment of the disclosure, the weight is determined by at least one of a seat detection sensor, a headlamp leveling sensor and/or a suspension sensor. These sensors represent suitable sensors for determining the weight of the vehicle accurately.

According to an embodiment of the disclosure, the vehicle parameters include at least one of a driver of the vehicle and a vehicle type. Depending on the driver, the brake actions, in particular their amount and intensity may vary. This is because a driver may tend to abrupt driving, speeding or to a low usage of an Advanced Driver-Assistance System, ADAS. A driver can be identified via a mobile phone carried by the driver, a key or by biometric data provided by a camera or fingerprint. A driving style may also be identified automatically, e.g. by Smart Cruise Control-Machine Learning, SSC-ML.

According to an embodiment of the disclosure, the vehicle parameters comprise a state of charge of a battery of the vehicle. The state of charge can be accessed from the battery management system. Determining the brake wear emissions includes a battery recuperation during the brake actions. Having a high state of charge, no recuperation is possible, so that the utilization of the brakes is more likely to be activated. In this way, a more accurate prediction of the brake wear emissions is possible.

According to an embodiment of the disclosure, determining the brake actions is based at least one of slopes, traffic lights, present traffic and critical areas, on the selected candidate route. Slopes, traffic lights and critical areas may be obtained by the route data from the navigational system. The present or live traffic may be obtained from the internet and may include traffic jams and congestion. A particular high driving speed or an emergency situation, e.g. near critical areas such as schools, may lead to high-intensity brake actions. By using the described information, the system can forecast the influencing factors and, predict the amount and intensity of brake actions on the planned route.

According to an embodiment of the disclosure, the method further includes accessing a navigational system for selecting a second candidate route between the departure location and the destination location. The method further includes determining second brake actions of the vehicle based on the selected second candidate route and the vehicle parameters. A further step of the method is determining second brake wear emissions based on the estimated alternative brake actions and the brake wear parameters. The method also includes selecting a preferred route out of the candidate routes based on the determined brake wear emissions. In this way, the route can be optimized in particular for the least brake wear emissions.

According to an embodiment of the disclosure, estimating brake actions is based on artificial intelligence that is trained by measured brake actions, which are compared to previously estimated brake actions on a selected route.

The artificial intelligence or machine learning system is thus permanently learning by monitoring and measuring the real brake actions and influencing factors, which may be obtained at least partly by sensors.

According to an embodiment of the disclosure, the measured brake action and/or the previously estimated brake actions are obtained from a fleet of multiple vehicles. The aforementioned learning data and related information can thus be shared to other fleet vehicles for further improvements, thereby realizing a swarm intelligence.

According to another aspect of the present disclosure, a non-transitory computer readable medium containing program instructions executed by a processor includes: program instructions that obtain a departure location and a destination location of a vehicle; program instructions that access a navigational system for selecting a candidate route between the departure location and the destination location; program instructions that access a database for obtaining vehicle parameters and a pre-defined data set of brake wear parameters; program instructions that determine brake actions of the vehicle based on the selected candidate route and the vehicle parameters; and program instructions that determine brake wear emissions based on the estimated brake actions and the pre-defined data set of brake wear parameters.

According to a further aspect of the present disclosure, a computer-implemented apparatus for estimating brake wear emissions of a vehicle includes: a processor and a memory, the processor configured to execute a computer program containing computer-readable instructions configured to: obtain a departure location and a destination location of the vehicle; access a navigational system for selecting a candidate route between the departure location and the destination location; access a database for obtaining vehicle parameters and a pre-defined data set of brake wear parameters; determine brake actions of the vehicle based on the selected candidate route and the vehicle parameters; and determine brake wear emissions based on the estimated brake actions and the pre-defined data set of brake wear parameters.

A vehicle may include the above-described apparatus.

The disclosure will be explained in greater detail with reference to exemplary embodiments depicted in the drawings as appended.

### BRIEF DESCRIPTION OF THE DRAWINGS

The accompanying drawings are included to provide a further understanding of the present disclosure and are incorporated in and constitute a part of this specification. The drawings illustrate the embodiments of the present disclosure and together with the description serve to explain the principles of the disclosure. Other embodiments of the present disclosure and many of the intended advantages of the present disclosure will be readily appreciated as they become better understood by reference to the following detailed description. The elements of the drawings are not necessarily to scale relative to each other. In the figures, like reference numerals denote like or functionally like components, unless indicated otherwise.

FIG. 1 schematically depicts a flow diagram of a method for estimating brake wear emissions of a vehicle according to an embodiment of the disclosure;

FIG. 2 schematically depicts a block diagram relating to method steps of the method for estimating brake wear emissions of a vehicle according to a further embodiment of the disclosure;

FIG. 3 schematically depicts a flow diagram of a method for estimating brake wear emissions of a vehicle according to a further embodiment of the disclosure;

FIG. 4 schematically depicts candidate routes selected in the method for estimating brake wear emissions of a vehicle according to a further embodiment of the disclosure;

FIG. 5 schematically depicts a flow diagram of a method for estimating brake wear emissions of a vehicle according to a further embodiment of the disclosure; and

FIG. 6 schematically depicts a vehicle according to an embodiment of the disclosure.

Although specific embodiments are illustrated and described herein, it will be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

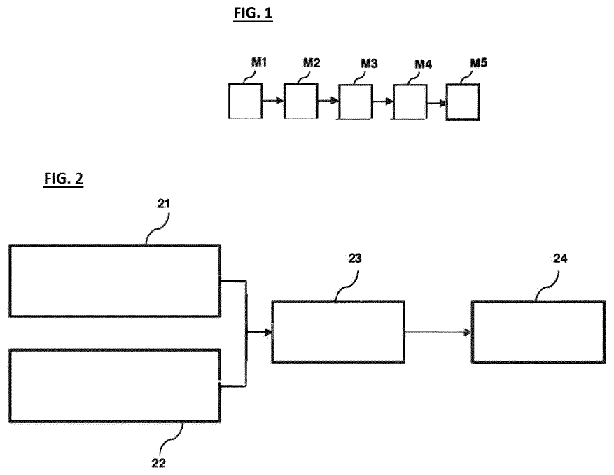

FIG. 1 schematically depicts a flow diagram of a method for estimating brake wear emissions of a vehicle 60 according to an embodiment of the disclosure.

In the computer-implemented method for estimating brake wear emissions of a vehicle 60, a departure location 1 and a destination location 2 is obtained M1. For example, a user may directly input the destination location 2 in a navigational system that can be accessed for obtaining this information. The user may also input the departure location 1. Alternatively or in addition, the departure location 1 is obtained by a global-position system-signal received by a corresponding receiver of the navigational system.

Based on the obtained information, a navigational system is accessed M2 for selecting a candidate route A, B, C between the departure location 1 and the destination location 2. The candidate route A, B, C is thus provided by the navigational system. An initial candidate route may be provided by the navigational system based on parameters like distance between departure location 1 and destination location 2, time of travel and other common parameters.

In further embodiments, the selection for a candidate route A, B, C may also employ an artificial intelligence, which selects the candidate route A, B, C based on training data that were provided by previous drives, as will be explained further below.

A database for obtaining vehicle parameters 3 and a pre-defined data set of brake wear parameters 4 are accessed M3 for the further steps of the method. The database may be physically located onboard a vehicle 60. Alternatively or in addition, the database may be located in a cloud server that can be accessed by a computer or navigational system onboard the vehicle 60.

Based on the selected route and the vehicle parameters 3, brake actions of a vehicle 60 are determined M4. Based on the estimated brake actions and the pre-defined data set of brake wear parameters 4 brake wear emissions are determined M5.

For example, the above steps may be performed by one or more controllers of the vehicle 60, and may constitute modules and/or devices of the vehicle 60, which may include a controller. For example, the above units of the vehicle 60 may constitute hardware components that form part of a controller (e.g., modules or devices of a high-level controller), or may constitute individual controllers each having a processor and memory. The vehicle 60 may include one or more processors and memory.

FIG. 2 schematically depicts a block diagram relating to method steps of the method for estimating brake wear emissions of a vehicle 60 according to a further embodiment of the disclosure.

The shown block diagram is based on the method for estimating brake wear emissions of a vehicle 60 and is compatible with the embodiment method as described with reference to FIG. 1.

Block 21 describes the determination M4 of the brake actions for the selected candidate route based on the vehicle parameters 3. The vehicle parameters 3 may include a weight of the vehicle 60. The weight is determined by at least one of a seat detection sensor, a headlamp leveling sensor and/or a suspension sensor. In some embodiments, the vehicle parameters 3 include at least one of a driver of the vehicle 60 and a vehicle type. For example, the amount and intensity of brake actions may strongly depend on the driver in that how often abrupt driving is occurring, how fast he is driving the vehicle 60, and how often an Advance Driving-Assistance System, ADAS, is used. The driver can be determined by a mobile phone that the drive carries, the key or biometric data obtained from a camera or a fingerprint. A driving style may also be identified automatically, e.g. by Smart Cruise Control-Machine Learning, SSC-ML.

Furthermore, in some embodiments, the vehicle parameters 3 comprise a state of charge of a battery of the vehicle 60. In these embodiments, determining brake wear emissions includes a battery recuperation during the brake actions. Having a high state of charge, no recuperation is possible, so that the utilization of the brakes is more likely to be activated. In the present embodiment, the brake actions including the amount and the intensity of the brake intensity for the selected candidate route are determined using the above items.

Block 22 describes the pre-defined data set of brake wear parameters 4, which is related to the brake wear emissions. In the present embodiment, the pre-defined data set of brake wear parameters 4 include basic brake wear emission parameters. These basic brake wear emission parameters may include characteristic particle emissions. These brake wear parameters 4 of the pre-defined data set have been determined during the research and development phase and may include at least one of a brake type and a brake design. The basic brake wear emission parameters include at least one of a particle size, a distribution of the particle size, and a flow direction of the particles.

Block 23 describes the predicted or estimated brake wear emissions that has been determined based on the determined brake actions in block 21 and the pre-defined data set of brake wear parameters 4 in block 22.

The output, which is the amount of brake wear emissions for the selected candidate route, is delivered in block 24 for route optimization, which will be describe further below with reference to FIGS. 3 to 5, for minimizing the brake wears emission on a route between the departure location 1 and the destination location 2.

FIG. 3 schematically depicts a flow diagram of a method for estimating brake wear emissions of a vehicle 60 according to a further embodiment of the disclosure.

The flow diagram shown in FIG. 3 is based on and compatible with the method for estimating brake wear emissions of a vehicle 60 that has been described with reference to FIG. 1.

Block 30 describes the previous method, which provides an estimated brake wear emissions for an initial candidate route A, B, C.

In addition, the method shown in FIG. 3 further includes accessing 31 a navigational system for selecting a second candidate route A, B, C between the departure location 1 and the destination location 2.

Second brake actions of the vehicle 60 are based on the selected second candidate route A, B, C and the vehicle parameters 3 are determined in block 32.

In the following step, second brake wear emissions based on the estimated second brake actions and the brake wear parameters 4 are determined in block 33.

In block 34, a preferred route out of the candidate routes A, B, C determined at block 30 and block 31 based on the determined brake wear emissions is selected. The here described method steps are repeated e.g. until the preferred route does not change for a predetermined amount of repetitions made. In each repetition step, the selection of the new route may be based on the previously selected routes and may include an attempt to improve the brake wear emission, e.g. by avoiding of critical areas, as will be described further below.

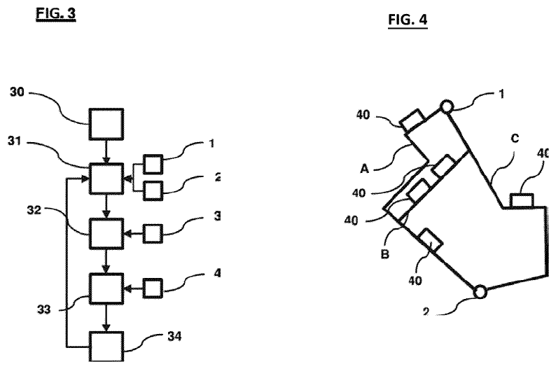

FIG. 4 schematically depicts candidate routes A, B, C selected in the method for estimating brake wear emissions of a vehicle 60 according to a further embodiment of the disclosure.

The candidate routes A, B, C depicted the brake actions is based at least on one of slopes, traffic lights, present traffic and critical areas, on the selected candidate route.

In the depicted embodiment, the number of critical area 40 influences the preferred route out of a selected first candidate route A, a second candidate route B and a third candidate route C, as will be described as follows. For each route, the distance and travel time is extracted from the route data provided by the navigational system. For the distance and the travel time, the difference to the best candidate route is then calculated. Furthermore, a number of brake actions is determined based on the route data and the vehicle data. By the pre-defined set of brake wear parameter 4, the brake wear emissions for each candidate route A, B, C are calculated. Table 1 summarizes the results of the candidate routes A, B, C shown in FIG. 4.

TABLE 1

| | | | | | No. of | Calculated |
|---|---|---|---|---|---|---|
| | | Δ best | Travel | Δ best | brake | brake wear |
| Route | Distance | dist | time | travel | actions | emissions |
| A | 4 km | +33% | 9 min | +28% | 6 | 42 mg |
| B | 3 km | Best | 7 min | Best | 5 | 38 mg |
| C | 6 km | +20% | 8 min | +14% | 4 | 25 mg |

In a next stage, a ranking of the candidate routes A, B, C according to the number of critical area and the determined or estimated brake wear emissions is made. A candidate route A receives 3 points for the highest ranking, i.e. best position, 2 points for the second best position and 1 point for the third best position. According to the example candidate routes shown in FIG. 4 and summarizes in table I, the preferred route is determined to be route C, as it is summarized in table 2 as follows.

TABLE 2

| | Ranking no. of | Ranking brake wear | |
|---|---|---|---|
| Route | critical areas | emission | Sum of points |
| A | 22 | 1 | 3 |
| B | 13 | 2 | 3 |
| C | 31 | 3 | 6 |

It is understood that further or different criteria may be used for selecting the preferred route. For example, a critical area may be classified according to their type and/or time of the day. For example, a playground or hospital may be considered less critical than a school at certain time of weekdays, where school begins or ends. Optionally, the selection of the route can be conducted by avoiding critical areas, such as schools, playground, hospitals etc., completely. In particular, a present traffic is preferably considered for selecting the candidate routes A, B, C since traffic jams, congestions and emergencies are expected to increase with increased traffic, leading to an increased amount and intensity of brake actions. Live traffic data can be obtained from the internet over, e.g., a vehicle-to-everything, V2X, connection.

FIG. 5 schematically depicts a flow diagram of a method for estimating brake wear emissions of a vehicle 60 according to a further embodiment of the disclosure.

The flow diagram shown in FIG. 5 is based on and compatible with the method for estimating brake wear emissions of a vehicle 60 that has been described with reference to FIG. 1 and FIG. 3.

In block 51, a software for conducting the inventive method is launched.

In block 52, the initial candidate route A, B, C is selected by the input of the driver. An initial candidate route A, B, C is based on a departure location 1 and a destination location 2 input by the driver.

In block 53, the brake actions are determined based on vehicle parameters 3. At this stage, the vehicle parameters 3 are based on data provided by an artificial intelligence, as will be described further below. In the present embodiment, brake actions are thus determined based on artificial intelligence that is trained by measured brake actions, which are compared to previously estimated brake actions on a selected route.

In block 54, the potential brake wear emissions on the selected route are determined or estimated based on the determined or predicted brake actions and a pre-defined data set of brake wear parameters 4. This pre-defined data set of brake wear parameters 4 may include basic brake wear emission parameters 41, 42, 43. In the present embodiment, these basic brake wear emission parameters includes a first database 41, a second database 42 and a third database 43. The first database 41 includes result from a CFD simulation, which includes a brake particle flow, e.g. from caliper through the rim, airborne particle flow. These data may be optimized by particle image velocimetry. The basic brake wear parameters 4 may also include a particle size, a distribution of the particle size, and a flow direction of the particles. The second database 42 contains a design of the brake or the brake system type and a design of a surface of a bumper, a fender, a wheel guard, or a rim. The brake system type may include e.g. a brake pressure, a design of the discs, the pads or the calipers. The third data 43 may include a vehicle type, the weight and its loading. This provides e.g. the amount of PM10 particles per disc and pads from a brake test operation. Based on the above the brake wear emissions are determined in block 54.

In block 55, the decision is made whether the calculated value of brake wear emissions in block 54 are sufficiently low. If not, then an alternative candidate route will be proposed for reduction of the brake wear emission per route in block 551. In case, the alternative route provides lower brake wear emission, it is marked, for example by a color such as green. In block 552, the distance, critical areas such as hospitals, schools, playgrounds, city parks and others are checked and evaluated. The best of the selected alternative route is then input to block 54 for determining or estimating the brake wear emission for that route by accessing the pre-defined data set of brake wear parameters.

In case, the calculated value of brake wear emissions in block 54 are sufficiently low, the driver is requested to confirm the preferred route in block 56. The driver then drives the determined preferred route and the brake actions are monitored, block 57.

In block 571, the vehicle route and driving profile is recorded and at the end of the trip uploaded to a cloud server. The amount and intensity of the actual braking actions are compared with the predicted brake actions. These comparison data are then used for predicting brake actions as in block 53. By this, the model of the artificial intelligent predicting the brake actions can be trained to provide more accurate values for a further trip.

In some embodiment, the measured or monitored actual brake action and/or the previously estimated brake actions are obtained and compared from a fleet of multiple vehicles.

Block 58 indicates the end of driving and monitoring.

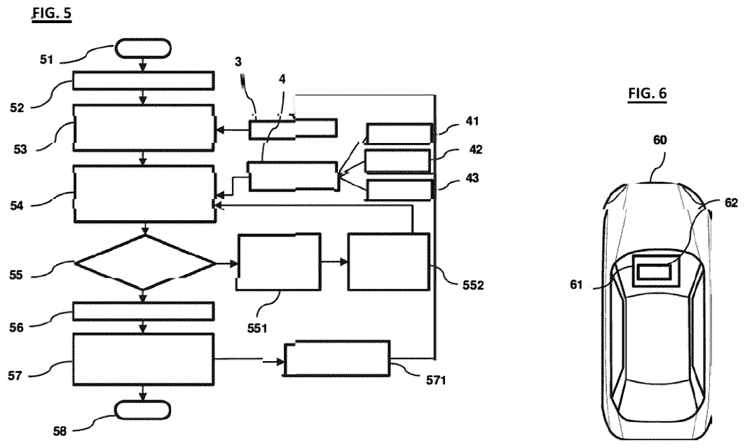

FIG. 6 schematically depicts a vehicle 60 according to an embodiment of the disclosure.

FIG. 6 shows a vehicle 60 comprising a computer-readable storage medium 61. The storage medium 61 can be arranged in a computer of the vehicle 60 or a navigational system onboard the vehicle 60. The computer-readable storage medium 61 comprises a computer program 62, which includes computer-readable instructions causing a computer to execute the computer-implemented method as described above with reference to FIGS. 1 to 5.

In the foregoing detailed description, various features are grouped together in one or more examples or examples with the purpose of streamlining the disclosure. Many other examples will be apparent to one skilled in the art upon reviewing the above specification. The embodiments were chosen and described in order to explain the principles of the disclosure and its practical applications, to thereby enable others skilled in the art to utilize the disclosure and various embodiments with various modifications as are suited to the particular use contemplated.

What is claimed is:

1. A computer-implemented method for estimating brake wear emissions of a vehicle, the method comprising:
obtaining, by a controller, a departure location and a destination location of the vehicle;
accessing, by the controller, a navigational system for selecting a candidate route between the departure location and the destination location;
accessing, by the controller, a database for obtaining vehicle parameters and a pre-defined data set of brake wear parameters;
determining, by the controller, brake actions of the vehicle based on the selected candidate route and the vehicle parameters; and
determining, by the controller, brake wear emissions based on the estimated brake actions and the pre-defined data set of brake wear parameters.

2. The method according to claim 1, wherein the pre-defined data set of brake wear parameters include basic brake wear emission parameters including characteristic particle emissions.

3. The method according to claim 2, wherein the basic brake wear emission parameters include at least one of a particle size, a distribution of the particle size, or a flow direction of the particles.

4. The method according to claim 1, wherein the pre-defined data set of brake wear parameters include at least one of a brake type or a brake design.

5. The method according to claim 1, wherein the vehicle parameters include a weight of the vehicle.

6. The method according to claim 5, wherein the weight is determined by at least one of a seat detection sensor, a headlamp leveling sensor, or a suspension sensor.

7. The method according to claim 1, wherein the vehicle parameters include at least one of a driver of the vehicle or a vehicle type.

8. The method according to claim 1, wherein the vehicle parameters comprise a state of charge of a battery of the vehicle,

9. The method according to claim 8, wherein determining the brake wear emissions includes determining a battery recuperation during the brake actions.

10. The method according to claim 1, wherein determining the brake actions is based at least on at least one of slopes, traffic lights, or traffic information, on the selected candidate route.

11. The method according to claim 1, further comprising:
accessing a navigational system for selecting a second candidate route between the departure location and the destination location;
determining second brake actions of the vehicle based on the selected second candidate route and the vehicle parameters;
determining second brake wear emissions based on the estimated second brake actions and the brake wear parameters; and
selecting a preferred route out of the candidate routes based on the determined second brake wear emissions.

12. The method according to claim 1, wherein estimating the brake actions is carried out using artificial intelligence that is trained by measured the brake actions, as compared to previously estimated brake actions on a selected route.

13. The method according to claim 12, wherein the measured brake action or the previously estimated brake actions are obtained from multiple vehicles.

14. A non-transitory computer readable medium containing program instructions executed by a processor, the computer readable medium comprising:
program instructions that obtain a departure location and a destination location of a vehicle;
program instructions that access a navigational system for selecting a candidate route between the departure location and the destination location;
program instructions that access a database for obtaining vehicle parameters and a pre-defined data set of brake wear parameters;
program instructions that determine brake actions of the vehicle based on the selected candidate route and the vehicle parameters; and
program instructions that determine brake wear emissions based on the estimated brake actions and the pre-defined data set of brake wear parameters.

15. A computer-implemented apparatus for estimating brake wear emissions of a vehicle, the apparatus comprising:
a processor and a memory, the processor configured to execute a computer program containing computer-readable instructions configured to:
obtain a departure location and a destination location of the vehicle;
access a navigational system for selecting a candidate route between the departure location and the destination location;
access a database for obtaining vehicle parameters and a pre-defined data set of brake wear parameters;
determine brake actions of the vehicle based on the selected candidate route and the vehicle parameters; and
determine brake wear emissions based on the estimated brake actions and the pre-defined data set of brake wear parameters.

16. The apparatus according to claim 15, wherein the pre-defined data set of brake wear parameters include basic brake wear emission parameters including characteristic particle emissions.

17. The apparatus according to claim 15, wherein the pre-defined data set of brake wear parameters include at least one of a brake type or a brake design.

18. The apparatus according to claim 15, wherein the vehicle parameters include a weight of the vehicle.

19. The apparatus according to claim 18, wherein the weight is determined by at least one of a seat detection sensor, a headlamp leveling sensor, or a suspension sensor.

20. A vehicle comprising the apparatus of claim 15.
